(19) United States
(12) Patent Application Publication
(10) Pub. No.: US 2014/0274638 A1
(43) Pub. Date: Sep. 18, 2014

(54) FOLDING DEVICE OF A PRINTING PRESS AND METHOD FOR OPERATING THE FOLDING DEVICE

(71) Applicant: manroland web systems GmbH, Augsburg (DE)

(72) Inventor: Tilmar GEISLER, Augsburg (DE)

(73) Assignee: manroland web systems GmbH, Augsburg (DE)

(21) Appl. No.: 14/216,286

(22) Filed: Mar. 17, 2014

(30) Foreign Application Priority Data
Mar. 18, 2013 (DE) 10 2013 102 729.6

(51) Int. Cl. B26D 7/27; B65H 45/16

(52) U.S. Cl. CPC B26D 7/27; B65H 45/16
USPC 493/320; 493/324

(57) ABSTRACT

A folding device of a printing press and a method for operating the folding device is disclosed. The folding device includes a first cylinder with a first assembly and a second cylinder with a second assembly. The first assembly interacts with the second assembly during a folding operation. A relative position between the first cylinder and the second cylinder is variable in a circumferential direction such that a circumferential relative position between the first assembly and the second assembly is variable.

This application claims the priority of German Patent Document No. DE 10 2013 102 729.6, filed Mar. 18, 2013, the disclosure of which is expressly incorporated by reference herein.

### BACKGROUND AND SUMMARY OF THE INVENTION

The invention relates to a folding device of a printing press. The invention furthermore relates to a method for operating the folding device.

From practice, folding devices of printing presses with the help of which transverse folds and/or longitudinal folds can be formed on signatures which are severed from a printed, in particular web-like, substrate are already known. Here, pin-type folding devices and gripper-type folding devices are distinguished in principle, namely dependent on whether so-called folding knife cylinders of the folding devices utilize pins or grippers for position fixing of the signatures to be folded on the folding knife cylinder. From practice it is likewise already known to collect multiple signatures into a signature stack during the folding of the signatures.

From DE 44 26 987 A1 a folding device of a printing press with multiple cylinders is known, namely with a cutting cylinder, a pin and folding knife cylinder, a folding jaw cylinder and a gripper and folding knife cylinder. By way of the cutting cylinder, signatures can be severed from the printed substrate. Between the pin and folding knife cylinder and the folding jaw cylinder, first transverse folds can be formed on the signatures and between the folding jaw cylinder and the gripper and folding knife cylinder, two transverse folds can be formed on the signatures.

From DE 44 26 987 A1 it is known furthermore that the pin and folding knife cylinder, the folding jaw cylinder and the gripper and folding knife cylinder each consists of two cylinder bodies or cylinder segments that can be twisted relative to one another. Thus, the relative position of the cylinder bodies of the pin and folding knife cylinder, the relative position of the cylinder bodies of the folding jaw cylinder and the relative position of the cylinder bodies of the gripper and folding knife cylinder is variable in order to change a cut-of and/or a positive overlap setting.

Thus it is possible according to this prior art to change the circumferential distance between the pins which are assigned to a first cylinder body of the pin and folding knife cylinder and the folding knives which are assigned to a second cylinder body of the pin and folding knife cylinder by twisting the cylinder segments of the same. On the folding jaw cylinder, the circumferential relative position between folding jaws which are assigned to the first cylinder body of the folding jaw cylinder and which are involved in the forming of the first transverse fold and the folding jaws which are assigned to the second cylinder body of the folding jaw cylinder and which are involved in the forming of the second transverse fold is variable by twisting the cylinder body of the same. In the region of the gripper and folding knife cylinder, the circumferential distance between the grippers which are assigned to the first cylinder body of the gripper and folding knife cylinder and the folding knives which are assigned to the second cylinder body of the gripper and folding knife cylinder is variable by twisting the cylinder body of the same.

As explained above, a cut-off changeover, for example from parallel fold to delta fold can be performed because of this. The so-called positive overlap can also be adjusted.

In particular when with the folding device known from DE 44 26 987 A1 for the cut-off changeover and/or positive overlap changeover the cylinder bodies of the pin and folding knife cylinder, folding jaw cylinder and gripper and folding knife cylinder are twisted relative to one another, the relative position between the interacting assemblies of different cylinders remains unchanged here. Accordingly, the relative position on the one hand between the folding knives of the pin and folding knife cylinder and the folding jaws of the folding jaw cylinder which are involved in the forming of the first transverse fold on the other hand remains the same.

Starting out from this, the object of the present invention is based on creating a new type of folding device of a printing press and a method for operating the folding device.

According to the invention, the relative position between at least two interacting cylinders in the circumferential direction is variable in such a manner that the circumferential relative position of assemblies which interact during the folding and are assigned to the cylinders is variable. With the invention, a folding device of a printing press is proposed for the first time, in which the circumferential relative position of different assemblies interacting during the folding and which are assigned to different cylinders is variable. Thus, for example, the circumferential relative position between folding knives of the pin and folding knife cylinder and folding jaws of a folding jaw cylinder is variable. Likewise, the circumferential relative position between folding knives of the gripper and folding knife cylinder and folding jaws of the folding jaw cylinder is variable. Because of this, the function of the folding device can be improved in particular when in a so-called collecting mode a multiplicity of signatures are collected on top of one another in a so-called collecting mode and forms then have to be formed on thick signature stacks. According to an advantageous further development of the invention, the circumferential relative position between the interacting assemblies of the cylinder is variable with the help of a driving system of the cylinders. Preferentially, the interacting cylinders for this purpose are coupled via helical spur gears on the drive side, wherein the circumferential relative position between the interacting assemblies of the cylinders is variable through an axial shifting of at least one of the helical spur gears. Alternatively, the interacting cylinders are coupled via spur gears and a phase shifter gearbox on the driving side, wherein the circumferential relative position between the interacting assemblies of the cylinders can then be varied through the phase shifter gearbox. Furthermore, the interacting cylinders can be alternatively driven via individual drives, wherein the circumferential relative position between the interacting assemblies of the cylinders can then be varied through the individual drives.

Changing the circumferential relative position between the interacting assemblies of the cylinders with the help of the driving system of the cylinders is particularly simple and therefore advantageous. Particularly preferred is a configuration of the invention, in which the cylinders of the folding device are coupled on the driving side via helical spur gears, wherein through axial shifting of at least one of the helical spur gears the circumferential relative position of the respective assemblies of the cylinders which are involved during the folding can then be varied.

According to an advantageous further development of the invention, the circumferential relative position between the folding knives which are assigned to the, or each, folding knife cylinder and folding jaws which are assigned to the folding jaw cylinder and which interact with the folding knives is variable in particular in such a manner that each folding knife, adjustable to the product thickness with respect to the distance from a folding jaw, can be introduced into an opened folding jaw preferentially in the middle.

With this configuration of the invention a bending of the folding knife or of the folding jaw when forming the fold can be counteracted in particular when a multiplicity of signatures are collected on top of one another into a thick signature stack since even with a thick signature stack the respective folding knife can then always be introduced respect to the product thickness optimal position into the respective opened folding jaws preferentially in the middle, independently of the set maximum opening of the folding jaws.

Preferred further developments of the invention are obtained from the following description. Exemplary embodiments of the invention are explained in more detail with the help of the drawings without being restricted to these.

### BRIEF DESCRIPTION OF THE DRAWINGS

FIG. 1 illustrates a first embodiment of a folding device of the present invention;

FIG. 2 illustrates a second embodiment of a folding device of the present invention;

FIG. 3 is the detail A of the folding device of FIG. 1;

FIG. 4 is the detail B of the folding device of FIG. 2;

FIG. 5 illustrates driving-side details of the folding device of FIG. 2;

FIG. 6 is a detailed representation of the first folding knife cylinder of the folding device of FIG. 1 or 2;

FIG. 7 is a detail in the region of a folding jaw; and

FIG. 8 is a design detail of a preferred embodiment of the folding device.

### DETAILED DESCRIPTION OF THE DRAWINGS

The present invention relates to a folding device and to a method for operating such a folding device.

FIG. 1 exemplarily shows a first folding device 10 of a printing press, which in the exemplary embodiment of FIG. 1 comprises three cylinders interacting during the folding, namely a cutting cylinder 11, a folding knife cylinder 12 and a folding jaw cylinder 13. With the help of the cutting cylinder 11, which in the shown exemplary embodiment carries two cutting knives 15, signatures 16 can be severed from a printed substrate web 14, which are gripped by the folding knife cylinder 12 and transported in the direction of the folding jaw cylinder 13, wherein the signatures 16 are transferred from the folding knife cylinder 12 to the folding jaw cylinder 13 subject to forming a transverse fold. In the exemplary embodiment of FIG. 1, the folding knife cylinder 12 is embodied as a pin and folding knife cylinder 12, which comprises multiple pins 17 for holding the severed signatures 16 on the outer circumference of the folding knife cylinder 12, and which furthermore comprises multiple folding knives 18, which during the forming of the transverse folds in the region between the folding knife cylinder 12 and the folding jaw cylinder 13 dip into folding jaws 19 of the folding jaw cylinder 13. In FIG. 1, transversely folded signatures are marked with the reference number 16′.

This function principle can also be transferred to gripper folding units.

FIG. 3 shows the detail A of FIG. 1 in the transfer region between the folding knife cylinder 12 and the folding jaw cylinder 13, wherein FIG. 3 shows a signature 16, which is held on a leading edge of a pin 17 of the folding knife cylinder 12, and on which a transverse fold is formed in that a folding knife 18 of the folding knife cylinder 12 then presses the signature 16 into an opened folding jaw 19 of the folding jaw cylinder 13, wherein FIG. 3 shows the folding jaw 19 in an opened state. In the exemplary embodiment of FIG. 3, the folding jaw 19 is formed by a fixed folding strip 20 and a folding strip 21 which is moveable relative to the fixed folding strip 20. In contrast with this, both folding strips of the folding jaw can also be embodied in a moveable manner.

In order to be able to optimally utilize the folding devices 10 for different product thicknesses, but the adjusting travel of the moveable folding strip 21 or folding strips 21 however being predetermined because of the control elements and being limited as a rule, the maximum opening of the folding jaw 19 or folding jaws 19 can be variably set with suitable embodiment.

FIG. 2 shows a further exemplary embodiment of a folding device 10, which differs from the folding device 10 of FIG. 1 in that the folding device 10 of FIG. 2 comprises a further folding knife cylinder 22, which interacts with the folding jaw cylinder 13 for forming a second transverse fold on the signatures 16, wherein in FIG. 2 the signatures which are provided with two transverse folds are marked with the reference number 16″. To avoid repetitions, same reference numbers are used for same assemblies and in the following only details, by which the folding device 10 of FIG. 2 differs from the folding device 10 of FIG. 1, are discussed.

The folding device 10 of FIG. 2 comprises, as already mentioned, a further cylinder, namely the further folding knife cylinder 22 which interacts with the folding jaw cylinder 13 subject to forming further transverse folds on the signatures 16, wherein this further folding knife cylinder 22 in the shown exemplary embodiment is a gripper and folding knife cylinder 22, which on the one hand carries folding knives 23 and on the other hand grippers 24. The second transverse folds between the folding jaw cylinder 13 and the further folding knife cylinder 22 are formed in the transfer region B between the same, wherein FIG. 4 shows this transfer region B in detail.

Thus it is evident from FIG. 4 that the folding jaw cylinder 13 of the folding device 10 of FIG. 2 comprises first folding jaws 19a, which are involved in the forming of first transverse folds between the folding knife cylinder 12 and the folding jaw cylinder 13, and second folding jaws 19b, which are involved in the forming of second transverse folds between the folding jaw cylinder 13 and the further folding knife cylinder 22, wherein each of these folding jaws 19a and 19b in the shown exemplary embodiment in turn comprises a fixed folding strip 20a and 20b and a moveable folding strip 21a, 21b.

For forming a second transverse fold on a signature 16 between the folding jaw cylinder 13 and the gripper and folding knife cylinder 22, a gripper 24 of the gripper and folding knife cylinder 22 grips a signature provided with a first transverse fold in the region of the first transverse fold, wherein the folding knife 23 of the gripper and folding knife cylinder 22 presses this signature 16 into an opened folding jaw 19b of the folding jaw cylinder 13 subject to forming a second transverse fold on the signature 16.

FIG. 6 shows further details of the first folding knife cylinder 12, i.e., of the folding knife cylinder formed in FIGS. 1 and 2 as a pin and folding knife cylinder 12, which carries the pins 17 and the folding knives 18, wherein according to FIG. 6 the folding knife cylinder 12 comprises two cylinder bodies 25 and 26, which can be twisted relative to one another in the circumferential direction according to the arrow 27. A first cylinder body 25 carries the pins 17 and a second cylinder body 26 carries the folding knives 18. In order to be able to perform a cut-off changeover and/or a positive overlap changeover on the folding device 10, the two cylinder bodies 25, 26 can be twisted relative to one another in order to adapt the circumferential distance A between the pins 17 and the folding knife 18 of the pin and folding knife cylinder 12.

In the exemplary embodiment of FIG. 1, in which the folding jaw cylinder 13 merely comprises first folding jaws, the folding jaw cylinder 13 is embodied in one piece. In the exemplary embodiment of FIG. 2, by contrast, in which the folding jaw cylinder 13 comprises the first folding jaws 19a for forming the first transverse folds and the second folding jaws 19b for forming the second transverse folds, the folding jaw cylinder 13 analogously to the pin and folding knife cylinder 12 is formed of two cylinder bodies, wherein a first cylinder body comprises the folding jaws 19a and a second cylinder body the folding jaws 19b, the circumferential distance of which is variable by twisting the cylinder bodies relative to one another, in order to perform a cut-off changeover and/or a positive overlap changeover.

In an analogous manner, the gripper and folding knife cylinder 22 is also formed of two cylinder bodies, wherein a first cylinder body of the same carries the grippers 24 and a second cylinder body of the same carries the folding knives 23, the circumferential distance of which is variable by twisting the cylinder bodies of the gripper and folding knife cylinder 22.

This is also evident from FIG. 5, wherein FIG. 5 shows driving-side details of the folding device 10 of FIG. 2. Thus, FIG. 5 shows the driving-side toothing of cutting cylinder 11, pin and folding knife cylinder 12, folding jaw cylinder 13 and gripper and folding knife cylinder 22 via gears or spur gears, which are arranged in different gear planes and intermesh.

Furthermore, FIG. 5 shows the cylinder bodies 25 and 26 of the pin and folding knife cylinder 12, wherein the cylinder body 25 carries the pins 17 and the cylinder body 26 carries the folding knives 18. In addition to this, FIG. 5 shows the cylinder bodies 27 and 28 of the folding jaw cylinder 13, wherein the cylinder body 27 carries the first folding jaws 19a and the cylinder body 28 carries the second folding jaws 19b. They cylinder bodies 29 and 30 of the gripper and folding knife cylinder 22 are also shown, wherein the cylinder body 29 of the same carries the grippers 24 and the cylinder body 30 of the same carries the folding knives 23.

FIG. 5 shows furthermore that each of the cylinder bodies 25, 26 and 27, 28 and 29, 30 is assigned a gear 31, which are in engagement with gears 31 of interacting cylinders. Thus, FIG. 5 shows that a gear 31 which is assigned to the cylinder body 27 of the folding jaw cylinder 13 is in engagement with two further gears 31 in a gear plane, namely with a gear 31 assigned to the cylinder body 26 of the pin and folding knife cylinder 12 and a gear 31 assigned to the cylinder body 29 of the gripper and folding knife cylinder 22.

The gear 31 which is assigned to the cylinder body 25 of the pin and folding knife cylinder 12 is in engagement with a gear 31 in a further gear plane, which is assigned to the cutting cylinder 11. In a further gear plane, further gears 31 are in engagement, namely the gear which is assigned to the cylinder body 28 of the folding jaw cylinder 13 and the gear 31 of the gripper and folding knife cylinder 22 which is assigned to the cylinder body 30.

For the cut-off changeover and/or positive overlap changeover in the region of the cylinders 12, 13 and 22, the respective cylinder bodies 25, 26 and 27, 28 and 29, 30 respectively are twisted relative to one another, this being carried out by driving the gears 32, 33. With such a cut-off changeover or positive overlap changeover, the cylinder bodies 25 and 26 can be twisted relative to one another in the region of the pin and folding knife cylinder 12 in order to set the circumferential distance between the pins 17 and the folding knives 18. In the region of the folding jaw cylinder 13, the cylinder bodies 27 and 28 can be twisted relative to one another in order to change the distance between the folding jaws 19a and 19b. In the region of the gripper and folding knife cylinder 22, the cylinder bodies 29 and 30 can be twisted relative to one another in order to set the circumferential distance between the grippers 24 and the folding knives 23.

According to the prior art, this twisting during the cut-off changeover and/or positive overlap changeover is effected in such a manner that the relative position between the assemblies assigned to the different cylinders and interacting during the folding remains unchanged. Accordingly, the circumferential relative position between the folding knives 18 of the folding knife cylinder 12 and the folding jaws 19a of the folding jaw cylinder 13 and the folding jaws 19b of the folding jaw cylinder 13 and the folding knives 23 of the gripper and folding knife cylinder 22 remains unchanged according to the prior art.

FIG. 5 furthermore shows that all cylinders 11, 12, 13 and 22 of the folding device 10 can be driven from a common drive motor 34. Driving the gears 32 and 33 for bringing about the positive overlap changeover or cut-off changeover is effected via separate motors 35 and 36, namely in particular when clutches 37 and 38 assigned to the gears 32 and 33 are closed.

In terms of the present invention the relative position of at least two interacting cylinders of the folding device 10 is variable in the circumferential direction in such a manner that the circumferential relative position of the assemblies assigned to the different cylinders which interact during the folding is variable. The circumferential relative position between the assemblies of the different cylinders which interact during the folding can be preferentially varied with the help of the drive system of the cylinders.

Thus it is possible in the exemplary embodiments of FIGS. 1 and 2 to change the circumferential relative position between folding knives 18 assigned to the folding knife cylinder 12 and the folding jaws 19 and 19a respectively interacting with these folding knives 18 and which are assigned to the folding jaw cylinder 13, namely in such a manner that the respective folding knife 18 can be introduced into an opened folding jaw 19 or 19a in the, with respect to the product thickness, optimal position, preferentially in the middle.

Thus, FIG. 7 shows a folding jaw 19 and 19a with the folding legs 20, 21 and 20a, 21a respectively and the folding knife 18, which dips into the respective folding jaw 19, 19a in the middle, namely even in particular when, as shown in FIG. 7, a multiplicity of signatures 16 are collected into a relatively thick signature stack 39. In the process, bends on the folding knife 18 or on the folding jaw 19, 19a, which can form in the case of an orientation of the folding knife 18 with respect to the folding jaw 19 or 19a which is not in the middle, are avoided.

As already mentioned, the folding knife cylinder 12, which carries the folding knives 18, in the exemplary embodiment of FIGS. 1 and 2, comprises pins 17 in addition to the folding knives 18, wherein the pins 17 are assigned to the cylinder body 25 and the folding knives 18 are assigned to the cylinder body 26 of the folding knife cylinder 12. For the cut-off changeover and/or positive overlap changeover, the two cylinder bodies 25 and 26, as already explained, can be twisted relative to one another subject to changing the circumferential distance between the pins 17 and the folding knives 18. Independently of this, the circumferential relative position between the folding knives 18 and the folding jaws 19 or 19a can also be adjusted by twisting the second cylinder body 26 of the folding knife cylinder 12 and/or by twisting the folding jaw cylinder 13 or the cylinder body 27 of the same.

In the exemplary embodiment of FIGS. 2 and 5, in which the folding device 10 comprises the further folding knife cylinder 22 in addition to the folding knife cylinder 12 and the folding jaw cylinder 13, the circumferential relative position between the folding knives 23 assigned to the further folding knife cylinder 22 and the further folding jaws 19b which are assigned to the folding jaw cylinder 13 can be analogously varied, namely again in such a manner that the folding knives 23 can be introduced into an open folding jaw 19b again in the middle.

To this end, as already explained in connection with FIG. 5, both the folding jaw cylinder 13 and also the further folding jaw cylinder 22 are formed out of the cylinder bodies 27 and 28 and the cylinder bodies 29 and 30 respectively, which can be twisted relative to one another during a cut-off changeover and/or a positive overlap changeover, and wherein independently of this, the circumferential relative position in turn between the assemblies assigned to these cylinders 13, 22 and interacting during the folding can also be varied, namely in particular the circumferential relative position between the folding jaws 19a of the folding jaw cylinder 13 and the folding knives 18 of the folding knife cylinder 12 and the circumferential position between folding jaws 19b of the folding jaw cylinder 13 and the folding knives 23 of the further folding knife cylinder 22.

Changing the circumferential relative position between the folding jaws 19b of the folding jaw cylinder 13 and the folding knives 23 of the gripper and folding knife cylinder 22 can be effected by twisting the cylinder body 30 of the gripper and folding knife cylinder 22 carrying the folding knives 23 and/or by twisting the cylinder body 28 of the folding jaw cylinder 13 carrying the folding jaws 19b.

With the folding device 10 of FIG. 2, the circumferential relative position between the folding jaws 19a and the folding knives 18 can also be effected by twisting the cylinder body 27 of the folding jaw cylinder 13 carrying the folding jaws 19a.

Furthermore, the circumferential relative position between the cutting knives 15 of the cutting cylinder 11 and a cutting bar system 40, which in the shown exemplary embodiments of FIGS. 1 and 2 is assigned to the folding knife cylinder 12, is variable.

Accordingly, the object of the present invention is to twist assemblies on a folding device 10 which are assigned to different cylinders of the folding device 10 and which interact during the folding with respect to their circumferential relative position. Thus, the circumferential relative position between the folding knives and folding jaws which are assigned to the different cylinders is preferentially varied in order to ensure a preferentially middle dipping of the respective folding knife into the respective folding jaw even during the transverse folding of thick signature stacks and the wide opening of the folding jaws which is required for this purpose. This change of the circumferential relative position of assemblies assigned to different cylinders and interacting during the folding is entirely different from the twisting of the cylinder bodies of a cylinder which takes place during the cut-off changeover and/or positive overlap changeover.

As already explained, the changing of the circumferential relative position between the assemblies of different cylinders of the folding device which interact during the folding is carried out preferentially with the help of a driving system of the cylinders involved, wherein according to FIG. 5 the involved cylinders are coupled on the driving side via gears or spur gears 31.

According to a first advantageous configuration of the invention it is proposed to couple the respective interacting cylinders, i.e., in FIG. 5 the cutting cylinder 11 and the folding knife cylinder 12 and/or the folding knife cylinder 12 and the folding jaw cylinder 13 and/or the folding jaw cylinder 13 and the further folding knife cylinder 22, in each case via helical spur gears 31, wherein the change of the circumferential relative position between the assemblies of the different cylinders 11, 12 and/or 12, 13 and/or 13, 22 which interact during the folding takes place through an axial shift of at least one of the helical spur gears 31.

This axial adjustment of a helical spur gear and thus the adjustment of the circumferential relative position between the assemblies of the different cylinders which interact during the folding can take place in steps or alternatively continuously.

FIG. 8 shows details of a folding device 10 in the region of the folding knife cylinder 12 and of the folding jaw cylinder 13, with which a helical gear or spur gear 31 of the folding jaw cylinder 13 can be shifted in the axial direction relative to the helical gear or spur gear 31 of the folding knife cylinder 12 meshing with the same, in order to change the circumferential relative position between the folding knives of the folding knife cylinder 12 and the corresponding folding jaws of the folding jaw cylinder 13 in the process.

The axially shiftable gear or spur gear 31 of the folding jaw cylinder 13 in this case is assembled of two segments, namely of a radially inner segment 41 and a radially outer segment 42, wherein the radially inner segment 41 of the helical gear or spur gear 31 is clamped and thus axially non-shiftably mounted on the shaft of the folding jaw cylinder 13 with the help of clamping rings 43, and wherein the radially outer segment 42 of the helical gear or spur gear 31 is axially shiftably guided on the radially inner segment 41 according to the arrow 44, namely via a splined profiling 45 which is shown in the cross section C of FIG. 8. The axial shifting of the radially outer segment 42 of the helical gear 31 of the folding jaw cylinder 13 relative to the helical gear 31 of the folding knife cylinder 12 changes the circumferential relative position between the folding knives of the folding knife cylinder 12 and the folding jaws of the folding jaw cylinder 13.

The axial shifting of the helical gear 31 or of the outer segment 42 of the same is effected with the help of pneumatic cylinders 45 in the exemplary embodiment of FIG. 8, wherein however this adjustment need not take place pneumatically, but can rather also take place electrically or hydraulically. The axial repositioning of the outer segment 42 of the helical gear 31 of the folding jaw cylinder 13 in this case is effected between two stops 46 and 47, which define the two end positions of the segment 42 of the spur gear 31.

By way of the axial repositioning of the radially outer segment 42 of the gear 31 of the folding jaw cylinder 13 relative to the helical gear 31 of the folding knife cylinder 12, which is assigned to the cylinder body 26 of the folding knife cylinder 12, which carries the folding knives 18, described above, the circumferential relative position of the cylinder body 26 of the folding knife cylinder 12 is variable relative to the folding jaw cylinder 13 and thus the circumferential position of the folding knives 18 of the folding knife cylinder 12 relative to the folding jaws 19, 19a of the folding jaw cylinder 13, namely in such a manner that each folding knife 18 during the operation dips into a folding jaw with respect to the product thickness optimal position, preferentially in the middle, which folding jaw during the operation can be adjusted variably or variably wide.

It is pointed out here that the axial repositioning of helical gears for changing the circumferential relative position of assemblies of different cylinders of the folding device which interact during the folding is preferred but that this change of the circumferential relative position can also be brought about in another way. Thus, interacting cylinders can be coupled via spur gears or gears and a phase shifter gearbox, wherein the change of the circumferential relative position between the assemblies which are assigned to the different cylinders and which interact during the folding can then be varied through the phase shifter gearbox. It is also possible to drive the cylinders of the folding device via individual drives, wherein the changing of the circumferential relative position between the assemblies of the different cylinders which interact during the folding can then be varied through the individual drives. As already explained, the circumferential relative position between the assemblies which interact during the folding and which are assigned to different cylinders is variable continuously or in steps.

The invention furthermore relates to a method for operating such a folding device, wherein during the operation the circumferential relative position of at least two cylinders or of assemblies which are assigned to at least two cylinders and which interact during the folding is varied, namely preferentially in such a manner that the circumferential relative position of folding knives of one or multiple folding knife cylinders to the folding jaws of a folding jaw cylinder is varied, namely in particular in such a manner that each folding knife when forming a fold is introduced into an opened folding jaw in the middle. In the process, the variation of the circumferential relative position can be effected dependent on a thickness of a signature stack to be folded consisting of multiple individual signatures.

### LIST OF REFERENCE NUMBERS

10 Folding device
11 Cutting cylinder
12 Folding knife cylinder/pin and folding knife cylinder
13 Folding jaw cylinder
14 Substrate
15 Cutting knife
16 Signature
16′, 16″ Folded signature
17 Pin
18 Folding knife
19, 19a, 19b Folding jaw
20, 20a, 20b Folding strip
21, 21a, 21b Folding strip
22 Folding knife cylinder/gripper and folding knife cylinder
23 Folding knife
24 Gripper
25 Cylinder body
26 Cylinder body
27 Cylinder body
28 Cylinder body
29 Cylinder body
30 Cylinder body
31 Gear
32 Gear
33 Gear
34 Drive motor
35 Motor
36 Motor
37 Clutch
38 Clutch
39 Signature stack
40 Cutting bar system
41 Segment
42 Segment
43 Clamping element
44 Axial shift
45 Splined profiling
46 Stop
47 Stop

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folding device of a printing press, comprising:
a first cylinder with a first assembly; and
a second cylinder with a second assembly;
wherein the first assembly interacts with the second assembly during a folding operation;
and wherein a relative position between the first cylinder and the second cylinder is variable in a circumferential direction such that a circumferential relative position between the first assembly and the second assembly is variable.

2. The folding device according to claim 1, wherein the circumferential relative position between the first assembly and the second assembly is variable by a driving system of the first cylinder and the second cylinder.

3. The folding device according to claim 1, wherein the first cylinder and the second cylinder are coupled on a driving side via helical spur gears and wherein the circumferential relative position between the first assembly and the second assembly is variable through an axial shift of at least one of the helical spur gears.

4. The folding device according to claim 1, wherein the first cylinder and the second cylinder are coupled via spur gears on a driving side and wherein the circumferential relative position between the first assembly and the second assembly is variable through a phase shifter gearbox.

5. The folding device according to claim 1, wherein the first cylinder and the second cylinder are drivable via individual drives and wherein the circumferential relative position between the first assembly and the second assembly is variable through the individual drives.

6. The folding device according to claim 1, wherein the circumferential relative position between the first assembly and the second assembly is variable in steps or continuously.

7. The folding device according to claim 1, wherein the first cylinder is a folding knife cylinder and the first assembly is a folding knife, wherein the second cylinder is a folding jaw cylinder and the second assembly is a folding jaw, and wherein the circumferential relative position between the folding knife and the folding jaw is variable such that the folding knife is introducible into the folding jaw in a middle position of the folding jaw.

8. The folding device according to claim 7, wherein the folding knife cylinder comprises a first cylinder body that includes pins or grippers and a second cylinder body that includes the folding knife, wherein a circumferential relative position between the first cylinder body and the second cylinder body is variable, and wherein the circumferential relative position between the folding knife and the folding jaw is adjustable by twisting the second cylinder body of the folding knife cylinder and/or by twisting the folding jaw cylinder.

9. The folding device according to claim 1, further comprising:
a third cylinder with a third assembly;
wherein a relative position between the third cylinder and the second cylinder is variable in a circumferential direction such that a circumferential relative position between the third assembly and a further assembly of the second cylinder is variable.

10. The folding device according to claim 9, wherein the second cylinder comprises a first cylinder body and a second cylinder body wherein a circumferential relative position between the first cylinder body and the second cylinder body is variable, and wherein the circumferential relative position between the third assembly and the further assembly is variable by twisting the second cylinder body and/or by twisting the third cylinder.

11. The folding device according to claim 10, wherein the third cylinder comprises a first cylinder body and a second cylinder body wherein a circumferential relative position between the first cylinder body and the second cylinder body is variable, and wherein the circumferential relative position between the third assembly and the further assembly is variable by twisting the second cylinder body of the second cylinder and/or by twisting the first cylinder body of the third cylinder.

12. The folding device according to claim 1, further comprising a cutting cylinder, wherein a circumferential relative position between a cutting knife of the cutting cylinder and a cutting bar system of the first cylinder is variable.

13. A method for operating a folding device of a printing press, wherein the folding device includes:
a first cylinder with a first assembly; and
a second cylinder with a second assembly;
wherein the first assembly interacts with the second assembly during a folding operation;
and comprising the step of:
changing a relative position between the first cylinder and the second cylinder in a circumferential direction such that a circumferential relative position between the first assembly and the second assembly is changed.

14. The method according to claim 13, wherein the first cylinder is a folding knife cylinder and the first assembly is a folding knife, wherein the second cylinder is a folding jaw cylinder and the second assembly is a folding jaw, and wherein the circumferential relative position between the folding knife and the folding jaw is changed such that the folding knife is introduced into the folding jaw in a middle position of the folding jaw.
